(19) United States
(12) Patent Application Publication
(10) Pub. No.: US 2006/0184380 A1
(43) Pub. Date: Aug. 17, 2006

(54) XML-based resource data structures and networks managed by XML-based resource data structures

(75) Inventors: Michael D. Hall, Carrollton, TX (US); Anil K. Kandregula, Richardson, TX (US)

Correspondence Address: DAVIS MUNCK, P.C., P.O. Drawer 800889, Dallas, TX, 75380, US

(73) Assignee: SAMSUNG ELECTRONICS CO., LTD., Suwon-city (KR)

(21) Appl. No.: 11/325,780

(22) Filed: Jan. 5, 2006

Related U.S. Application Data
(60) Provisional application No. 60/653,149, filed on Feb. 15, 2005.

(51) Int. Cl. G06Q 99/00

(52) U.S. Cl. 705/1

(57) ABSTRACT

A network that uses XML-based resource data structures. The network comprises: i) a plurality of network elements; 2) a configuration manager for managing and configuring the plurality of network elements; and iii) a plurality of resource data structures suitable for configuring the plurality of network elements of the network. Each of the resource data structures is implemented using extensible Markup Language (XML) code.

### CROSS-REFERENCE TO RELATED APPLICATION AND CLAIM OF PRIORITY

The present application is related to U.S. Provisional Patent No. 60/653,149, filed Feb. 15, 2005, entitled “Network Element Common OA&M Platform System”. U.S. Provisional Patent No. 60/653,149 is assigned to the assignee of the present application and is hereby incorporated by reference into the present disclosure as if fully set forth herein. The present application hereby claims priority under 35 U.S.C. §119(e) to U.S. Provisional Patent No. 60/653,149.

### TECHNICAL FIELD OF THE INVENTION

The present application relates generally to communication and data networks and, more specifically, to the use of XML-based resource data structures for configuring and managing such networks.

### BACKGROUND OF THE INVENTION

Computer software is used in a wide range of applications, including business (or enterprise) applications, telecommunications, aerospace and defense systems, industrial (e.g., factory or process) control systems, agriculture, energy production and distribution, education, entertainment, and a plethora of other applications. In these applications, computer software frequently provides functions, methods, and/or behaviors that operate upon data that is formatted according to standard protocols.

Network element devices (e.g., cellular base stations or controllers, mobile switching centers, wireless access points, gateways, SoftSwitches, wireless handsets, server nodes, etc.) are complex computing platforms containing many physical components. These physical components may include radio frequency (RF) cards, interface boards, channel elements, trunk lines, vocoders, backplanes, process controllers, and the like.

From an operational (or management) viewpoint of the network, each of these components is typically referred to as a “managed resource”. Managed resources may also include logical resources such as frequency assignments (FAs) of cellular base stations, base station sectors, operational measurement groups, and the like. Additionally, the network element device itself may be regarded as a managed resource in some instances. Thus, the network element may be regarded as a managed resource containing other managed resources.

Managed resources support operational control via commands and internal control via system events. A managed resource may be represented within executable software code by one or more data structures that are referred to as a “resource data structure” (RDS). A resource data structure (RDS) describes the managed resource in terms of a collection of attributes that may be accessed programmatically. Each attribute is given a type according to its characteristics (e.g., string, character, integer, long, array, table, etc.) Each attribute has a current value as stored in the resource data structure. Resource data structures are accessed in support of internal operations and network management operations, such as update, retrieve, notify, lock, shutdown, and others.

However, when the format of a resource data structure is changed during a network update or during an error correction procedure (i.e., a patch operation), software applications that use the resource data structure often must be modified to accommodate the changed data format. Various approaches have been used to reduce the amount of change that must be made to application software when extending the software to new functions or to support new objects. For example, in class-based programming (e.g., C++, Java), sub-classes are derived from a base class to provide functionality for different data formats. However, this approach requires that the derived classes be conceived of and developed from the beginning.

Additionally, while the legacy application software may not need to be changed, new application software may be required to support the methods appropriate for the new data format. The problems associated with modifying software programs to accommodate changes in data structure formats is particularly acute in network applications where dozen, hundreds, or even thousands of network elements may require modification to accommodate the changed data formats.

Therefore, there is a need in the art for improved methods and structures for accommodating changes in resource data structures in network environments. In particular, there is a need for methods and structures for accommodating changes in resource data structures that do not require extensive changes in software applications that access the resource data structures.

### SUMMARY OF THE INVENTION

An improved method of resource data structure (RDS) implementation is provided for use in a variety of networks. The resource data structure is suitable for configuring a network element of the network and is implemented using extensible Markup Language (XML) code.

An improved network that uses XML-based resource data structures also is provided. The network comprises: i) a plurality of network elements; ii) a configuration manager for managing and configuring the plurality of network elements; and iii) a plurality of resource data structures suitable for configuring the plurality of network elements of the network. Each of the resource data structures is implemented using extensible Markup Language (XML) code.

A method of managing a plurality of network elements in a network also is provided. The method comprises the steps of: i) accessing a first resource data structure suitable for configuring a first network element of the network, wherein the first resource data structure is implemented as extensible Markup Language (XML) code; and ii) parsing the XML code of the first resource data structure and configuring the first network element. The method further comprises the step of generating from the XML code associated with the first resource data structure a binary resource data structure that may be accessed by the first network element. The method also comprises the step of storing data attribute values associated with the first resource data structure in a shared memory that may be accessed by the first network element.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system of networks in which network elements access improved resource data structures according to the principles of the disclosure;

FIG. 2 illustrates selected network elements in a communication network that implements XML-based resource data structures according to the principles of the present disclosure;

FIG. 3 illustrates a conventional C++ type resource data structure within a source code file that describes the configuration attributes of a managed resource such as a base transceiver subsystem (BTS);

FIG. 4 illustrates an XML-based resource data structure that describes the configuration attributes of a managed resource, such as a base transceiver subsystem (BTS), according to the principles of the present disclosure;

FIG. 5 is a flow diagram illustrating the processing of an XML RDS file during configuration management operations according to the principles of the present disclosure;

FIG. 6 is a flow diagram illustrating the processing of an XML RDS file during a resource update operation according to the principles of the present disclosure; and

FIG. 7 is a flow diagram illustrating the processing of an XML RDS file during a resource update operation from a configuration management device according to the principles of the present disclosure.

### DETAILED DESCRIPTION OF THE INVENTION

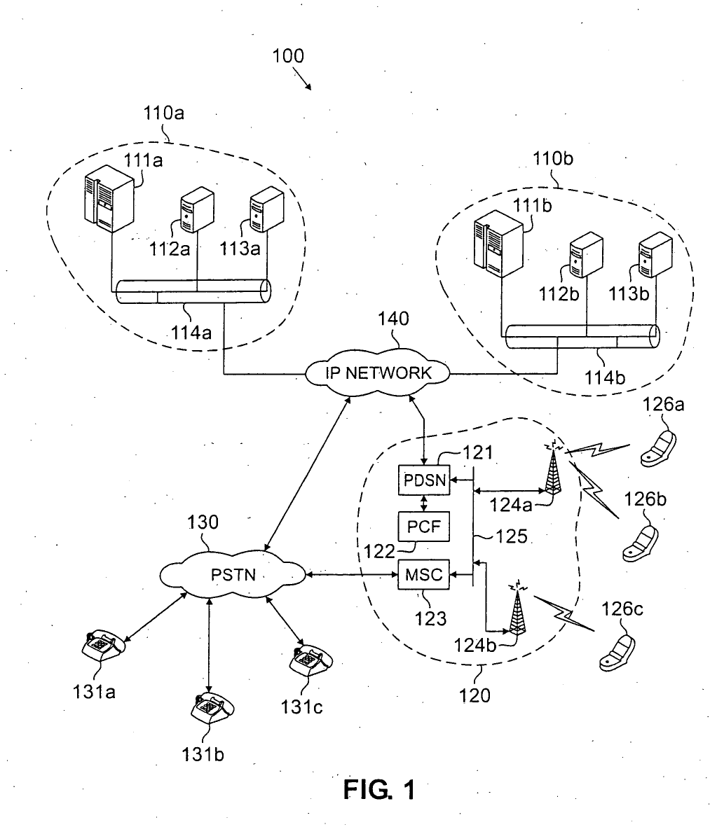

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged network.

The improved resource data structures disclosed herein are implemented as extensible Markup Language (XML) files that define the data structure(s) of resource type(s) to be processed by reusable (or generic) software application(s) within network elements. A software application accesses an XML file defining the data structure of one or more objects and the software application then adapts its processing in accordance with the XML definition of the data structure of the objects. The use of XML files allows the software applications to be written generically (i.e., without the use of hard-coded data structures). In effect, the programming data structure is read from the XML file, stored in memory, and operated on by the generic software application.

Advantageously, implementing resource data structures in XML format provides a mechanism for managing telecommunication network elements (NEs) that is adaptable to process management information for newly defined network elements, without modifying the executable software applications. In a telecommunication network environment, network elements may include, for example, core packet switches, wireless base stations, WiFi access points, routers, packet data server nodes (PDSNs), packet control function (PCF) units, mobile switching centers (MSCs), SoftSwitches, and innumerable other telecommunication nodes.

New types of network elements are constantly deployed into networks. Advantageously, the data structure associated with the new network element may be defined in an XML file according to the principles of the present disclosure. Thereafter, executable software on other network elements may read the XML file and adapt their operations to process the management information associated with the new network element based on the structure defined in the XML-based resource data structure (RDS). The executable software parses the XML file to determine the structure of the network element and uses this structure to interact with management information associated with the network element.

The use of XML-based resource data structures according to the principles of the present disclosure may also be extended beyond the specific field of telecommunication networks described above to the more general field of computer programs or software applications. Any software application (i.e., executable code) that is written to generically process objects whose data structures are determined by parsing an XML file definition of the object data structure falls within the scope of the present disclosure. This makes the software application highly reusable with only minimal labor. Thus, the present disclosure is applicable in all software application domains, including business (or enterprise) applications, telecommunications, aerospace and defense systems, industrial (e.g., factory or process) control systems, agriculture, energy production and distribution, education, entertainment, and many other applications.

FIG. 1 illustrates system 100, in which network elements access improved resource data structures according to the principles of the present disclosure. System 100 comprises a plurality of diverse network types, including exemplary proprietary networks 110a and 110b, exemplary wireless network 120, public switched telephone network (PSTN) 130, and wide-area Internet protocol. (IP) network 140. PSTN 130 provides conventional voice and fax service to a plurality of telephony devices 131, including exemplary telephony devices 131a, 131b and 131c. Wireless network 120 provides both voice and data service to a plurality of mobile terminals 126, including mobile terminals 126a, 126b, and 126c, according to any one of a variety of standards, including CDMA, GSM, TDMA, and the like. In an exemplary embodiment, IP network 140 may be the Internet 140.

Proprietary networks 110a and 110b may comprise any of a wide variety of both small-sized networks (e.g., local area networks (LANs), etc.) and large-sized networks (e.g., wide-area networks (WANs), etc.), including, for example, corporate (or enterprise) networks, industrial (e.g., factory or process) control networks, financial trading networks (e.g., commodities exchange, stock exchange), academic (or university) networks, among many others. Proprietary network 110a comprises a plurality of networks elements (NEs), including server 11a and network nodes 112a and 113a, among others, that are coupled by conventional network connection architecture 114a, which may be wireline or wireless. Similarly, proprietary network 110b comprises a plurality of networks elements (NEs), including server 111b and network nodes 112b and 113b, among others, that are coupled by conventional network connection architecture 114b, which also may be wireline or wireless. By way of example, connection architectures 114a and 114b may comprise Ethernets, token rings, or IEEE-802.11 wireless networks.

In corporate or academic embodiments, servers 111 may comprise mainframe computers and nodes 112 and 113 may comprise computer workstations. In industrial embodiments, nodes 112 and 113 may comprise individual process controllers and servers 111 may comprise central control systems that control and coordinate the overall operations of the individual process controllers.

Wireless network 120 comprises a plurality of networks elements (NEs), including, among others, packet data server node (PDSN) 121, packet control function (PCF unit) 122, mobile switch center (MSC) 123, and a plurality of base stations 124, including exemplary base stations 124a and 124b. The network elements in wireless network 120 are coupled by conventional network connection architecture 125, which may be wireline or wireless. By way of example; connection architecture 125 may comprise a high-speed Ethernet, a fiber optic system, or a microwave communication system. PDSN 121 and PCF unit 122 provide mobile terminals 126 with access to Internet 140. MSC 123 provides mobile terminals 126 with access to PSTN 130.

The network elements in proprietary networks 110, wireless network 120, PSTN 130, and IP network 140 may include both physical resources and logical resources. The sub-components of these network elements may also comprise network elements in their own right. For example, in PSTN 130, the network elements may include a variety of switch types, including SoftSwitches, service control points (SCPs), switch transfer points (STPs), trunk lines, gateways, and the like. However, individual line cards within a switch, for example, also may be viewed as network elements within the larger network element (i.e., the switch). Similarly, in wireless network 120, each one of base stations 124 may comprise a base station controller (BSC) and at least one base transceiver subsystem (BTS). From the network viewpoint, the BSC and each BTS may be regarded as individual network elements within the larger network element (i.e., the base station 124). Likewise, logical resources associated with base stations 124, such as the frequency assignment (FA) and the sectors of each base station 124, may be regarded as network elements.

The present disclosure provides a novel way of defining a resource data structure (RDS) for a managed resource within a network element. By defining the resource data structure using extensible Mark-up Language (XML) code, source code for applications may be written to parse and understand these structures in a generic manner. Thus, the underlying application code may be reused for different types of managed resources across elements obtain their critical data structures via XML files and then process management commands against these resources by using generic code operating on the resultant structures in memory. The resultant structures within the generic code can be either XML (as read in) or binary (after conversion for performance reasons).

XML is widely used in web services and provides a data representation syntax that allows diverse data to be shared across different platforms. XML syntax is simple and human-readable, yet flexible and powerful enough to accommodate complex data structures. The present disclosure extends the use of XML from web services into the telecommunication network element arena to describe critical data structures. The use of XML files to describe critical resource data structures is particularly advantageous in wireless and wireline networks where maximum flexibility is desired. By structuring the network element software around an XML definition, application software executing on the network element may be developed generically and becomes reusable from application to application. A new project simply builds a new XML file describing the new or modified RDS.

One particularly beneficial use of an XML file to define a resource data structure (RDS) is in network operation, administration and management (OA&M) applications where configuration and operational measurement data may be described using XML format. In a network environment, a configuration manager (CM) node performs the detailed recording and updating of information that describes the resources of a network, including all hardware, software, and logical components. A performance management (PM) node performs the collection and transfer of measurements depicting the operational performance of a managed resource.

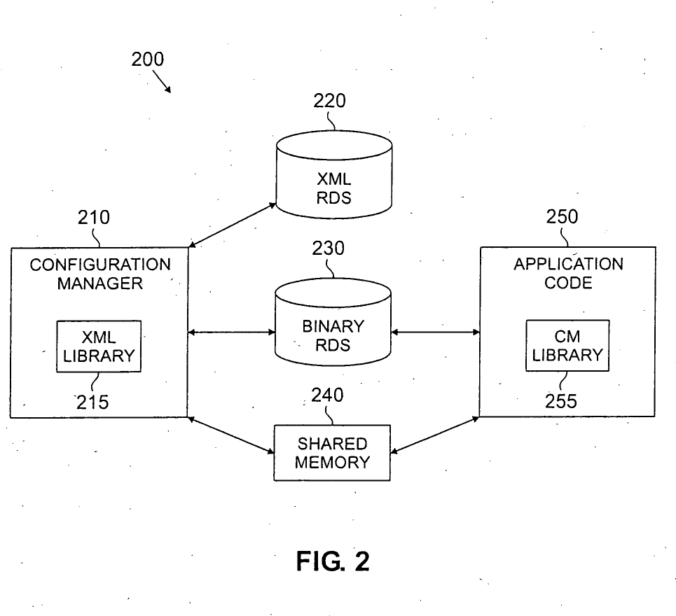

FIG. 2 illustrates selected network elements in a communication network 200 that implements XML-based resource data structures according to the principles of the present disclosure. Communication network 200 may be any one of proprietary networks 110, wireless network 120, PSTN 130, or IP network 140. Communication network 200 comprises configuration manager 210, XML-based resource data structure (RDS) file 220, optional binary resource data structure (RDS) file 230, shared memory 240, and application code 250, which resides within a network element (or managed resource).

Configuration manager 210 resides on a network element (i.e., a processing node) in communication network 200 and comprises XML library application programming interface (API) 215. Application code 250 comprises configuration management (CM) library application programming interface (API) 255. Application node 250 and shared memory 240 reside in a managed resource network element. XML RDS file 220 is associated with the managed resource network element and may reside in a database in network 200 that is external to the network element. Binary RDS file 230 also is associated with the network element and may reside in the network element. It will be understood that communication network 200 comprises a large number of network elements, each having an associated XML RDS file 220, optional binary RDS file 230, shared memory 240, and application code 250. However, for the purposes of simplicity and clarity, it is necessary only to illustrate and describe these components with respect to one network element.

Configuration manager 210 is essentially a collection of software components that provides generic code to read, parse, and understand the XML definitions in XML RDS file 220 in order to provide support for application code 250 and manager commands to access and update the configuration data. Communication network 200 may also comprise a performance manager (not shown) that is very similar to configuration manager 210. The performance manager is essentially a collection of software components that provides generic code to read, parse, and understand the XML definitions in order to provide support for application code 250 and manager commands to access and update operational measurement data.

In conventional telecommunication network elements, resource configuration is largely achieved through hard-coding data structures and behavior logic directly within the source code program itself. Programming languages (e.g., C++) may be used to explicitly define type structures for managed network elements. These type structures include all attributes which make up the resource.

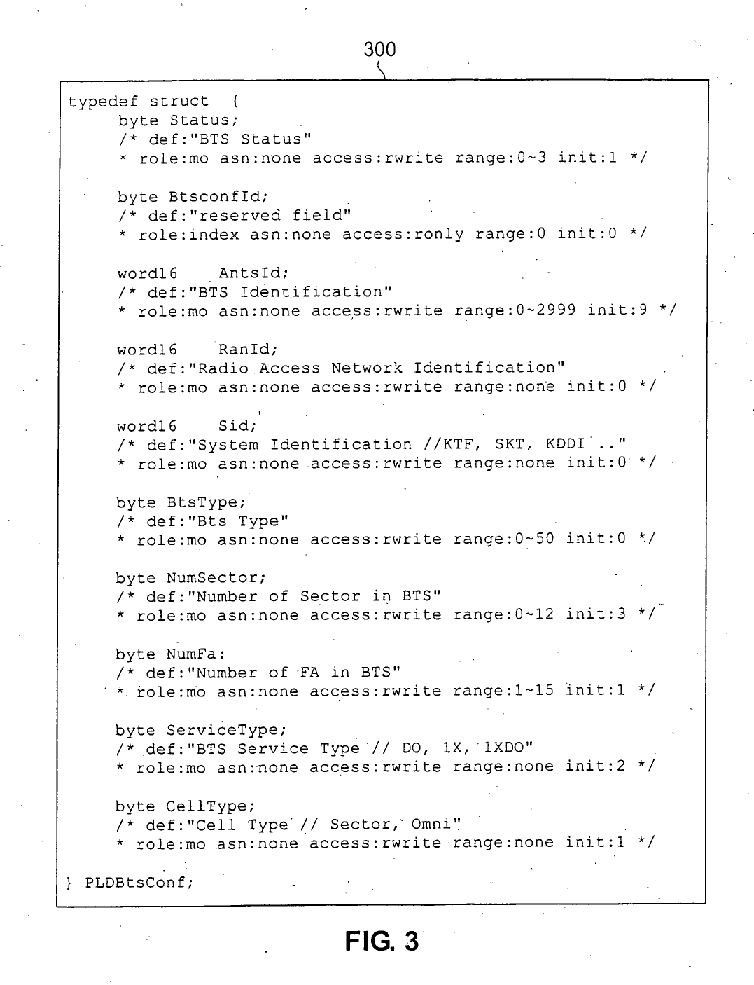

FIG. 3 illustrates conventional C++ type data structure 300 within a source code file that describes the configuration attributes of a managed resource, in this case a base transceiver subsystem (BTS). In addition to the structure depicted in FIG. 3, source code is developed to operate (modify, add, delete) on the conventional resource data structure. For example, a common operation in call processing or OA&M is to change the value of a specified attribute of the resource. Using the resource definition in FIG. 3, an example of this would be source code that accepts a request to modify the parameter NumSector from its current value (e.g., 0) to a new value (e.g., 3).

Unfortunately, this approach makes the source code specific to the resources being managed as defined by the current system. The resultant code (both type structures and behavior logic) is difficult to reuse in a new system that has different managed resources, since the new resources will have different type structures. Often, this forces network developers to start from scratch.

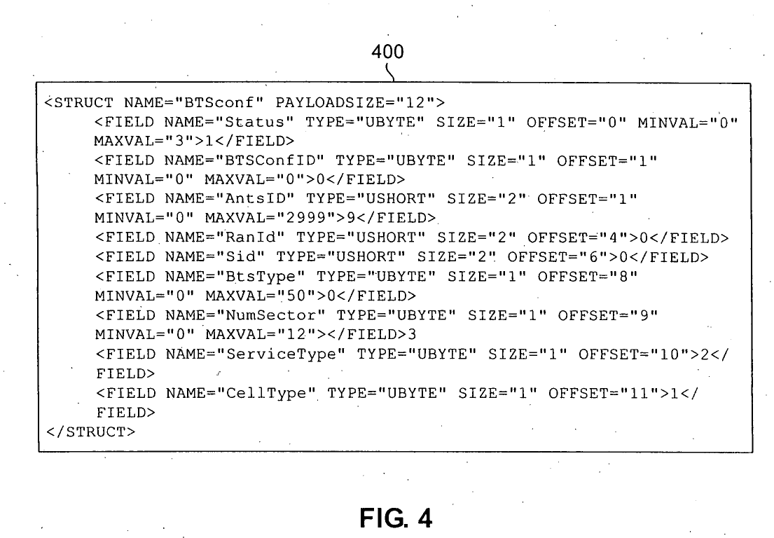

FIG. 4 illustrates XML-based resource data structure (RDS) file 400 that describes the configuration attributes of a managed resource, such as a base transceiver subsystem (BTS) according to the principles of the present disclosure. The XML RDS file 400 in FIG. 4 is essentially equivalent to C++ type data structure 300 in FIG. 3. However, the use of XML format in a resource data structure that defines a managed resource improves on conventional resource data structures in a number of ways. First, the definition of new resources involves only simple modifications to, or creation of, an XML file. Also, code that accesses and operates on the XML definitions may be written generically and reused in new applications. The use of reusable software components in turn reduces software development costs, reduces software maintenance costs, speeds up time-to-market, provides enhanced flexibility, and improves software quality through use of previously tested components.

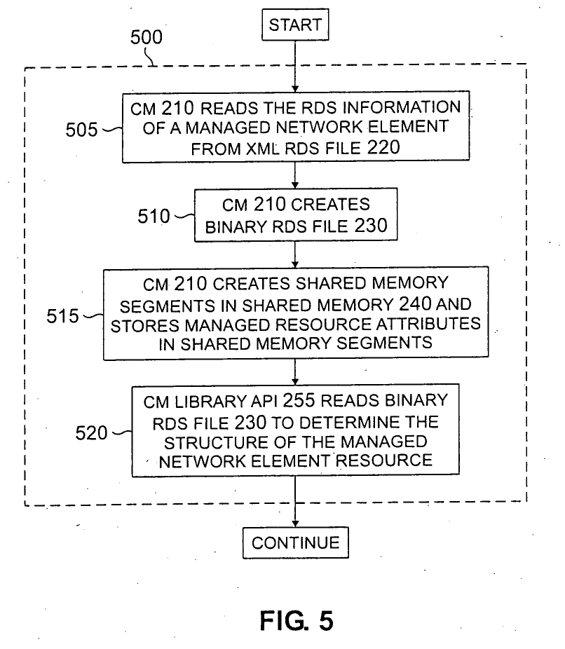

FIG. 5 illustrates flow diagram 500, which depicts the processing of XML RDS file 220 during configuration management operations according to the principles of the present disclosure. It will be understood that performance management operations proceed in a similar manner. Upon initialization, configuration manager 210 reads in the managed element resource data structure (RDS) from XML RDS file 220 (process step 505). Optionally, configuration manager 210 may create binary RDS file 230 (process step 510), which is a binary representation of the resource data structure described in XML RDS file 220. Binary RDS file 230 may be used by other applications, such as call processing, for performance reasons since processing binary code is much faster than processing XML code. An additional optimization is for the application to read the binary RDS file once and store it locally within memory so that subsequent access to the RDS avoids the disk access delay.

Next, configuration manager 210 creates shared memory segments based on the RDS specified within XML RDS file 230 and stores the shared memory segments in shared memory 240 (process step 515). The shared memory segments contain the actual data attribute values for each managed resource. CM library API 255 in application code 250 reads binary RDS file 230 to understand the structure of the resource types (process step 520). If binary RDS file 230 is not implemented, CM library API 255 reads XML RDS file 220 instead.

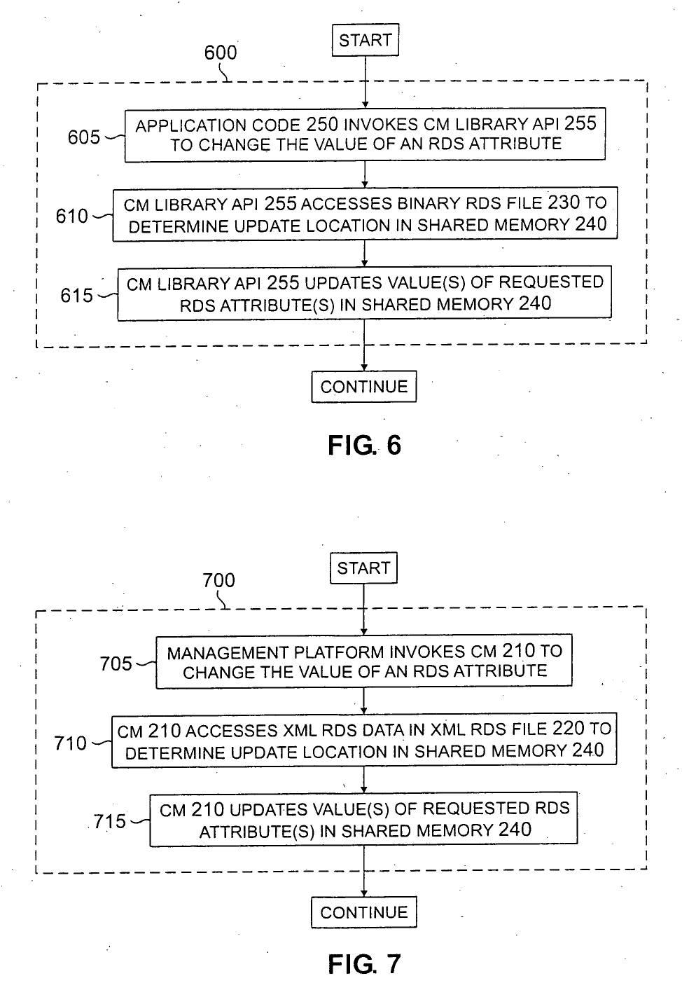

Based on processing needs, software applications, such as application code 250 may need to access and/or update the RDS associated with a managed resource. FIG. 6 illustrates flow diagram 600, which depicts the processing of XML RDS file 220 during a resource update operation from application code according to the principles of the present disclosure. It will be understood that performance management (PM) operations proceed in a similar manner. By way of example, the update is performed by application coded 250, which performs call processing. One example of an update operation is a request from a call processing application to modify the power level of a radio frequency (RF) card in a base station of a wireless network.

Initially, application code 250 invokes CM library API 255 to change the value of an RDS attribute (process step 605). CM library API 255 accesses the binary version of the RDS in binary RDS file 230 (or the version stored in local memory) to determine the location in shared memory 240 that requires the update (process step 610). Typically, CM library API 255 stores a copy of the RDS information within CM library API 255 in object form to avoid disk access for each invocation. CM library API 255 then updates the value(s) of the requested RDS attribute in shared memory 240 (process step 615). It is noted that interaction with configuration manager 210 is not required.

FIG. 7 illustrates flow diagram 700, which depicts the processing of XML RDS file 220 during a resource update operation from a management platform according to the principles of the present disclosure. It will be understood that performance management (PM) operations proceed in a similar manner. One example of this type of operation is a request from an element management system (commonly known as EMS) to command a control processor card to switch over to a standby card.

Initially, the management platform (not shown) invokes configuration manager 210 to change the value of an RDS attribute (process step 705). Configuration manager 210 accesses the XML version of the RDS (or binary RDS for optimization purposes) in XML RDS file 220 to determine the location in shared memory 240 that requires the update (process step 710). Configuration manager 210 then updates the value of the requested RDS attribute in shared memory 240 (process step 715). It is noted that interaction with application code 250 is not required.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a network, a resource data structure suitable for configuring a network element of the network, wherein the resource data structure is implemented as extensible Markup Language (XML) code.

2. The resource data structure as set forth in claim 1, wherein the network comprises a telecommunication network.

3. The resource data structure as set forth in claim 2, wherein the network comprises a wireless telecommunication network.

4. The resource data structure as set forth in claim 2, wherein the network comprises a wireline telecommunication network.

5. The resource data structure as set forth in claim 1, wherein the network comprises a data processing network.

6. The resource data structure as set forth in claim 5, wherein the network comprises a proprietary network.

7. The resource data structure as set forth in claim 6, wherein the network comprises one of: i) an enterprise network; ii) an industrial control system; and iii) a financial trading network.

8. The resource data structure as set forth in claim 6, wherein the network comprises a wide-area network.

9. The resource data structure as set forth in claim 6, wherein the network comprises a local-area network.

10. The resource data structure as set forth in claim 1, wherein the network comprises an Internet protocol network.

11. A network comprising:
a plurality of network elements;
a configuration manager for managing and configuring the plurality of network elements; and
a plurality of resource data structures suitable for configuring the plurality of network elements of the network, wherein each of the resource data structures is implemented as extensible Markup Language (XML) code.

12. The network as set forth in claim 11, wherein the configuration manager accesses a first resource data structure associated with a first network element and configures the first network element according to XML code associated with the first resource data structure.

13. The network as set forth in claim 12, wherein the configuration manager generates from the XML code associated with the first resource data structure a binary resource data structure that may be accessed by the first network element.

14. The network as set forth in claim 13, wherein the configuration manager stores data attribute values associated with the first resource data structure in a shared memory that may be accessed by the first network element.

15. The network as set forth in claim 11, wherein the network comprises a telecommunication network.

16. The network as set forth in claim 15, wherein the network comprises a wireless telecommunication network.

17. The network as set forth in claim 15, wherein the network comprises a wireline telecommunication network.

18. The network as set forth in claim 11, wherein the network comprises a data processing network.

19. The network as set forth in claim 18, wherein the network comprises a proprietary network.

20. The network as set forth in claim 19, wherein the network comprises one of: i) an enterprise network; ii) an industrial control system; and iii) a financial trading network.

21. The network as set forth in claim 19, wherein the network comprises a wide-area network.

22. The network as set forth in claim 19, wherein the network comprises a local-area network.

23. The network as set forth in claim 11, wherein the network comprises an Internet protocol network.

24. For use in a network comprising a plurality of network elements, a method of managing the plurality of network elements comprising the steps of:
accessing a first resource data structure suitable for configuring a first network element of the network, wherein the first resource data structure is implemented as extensible Markup Language (XML) code; and
parsing the XML code of the first resource data structure and configuring the first network element.

25. The method as set forth in claim 24, further comprising the step of generating from the XML code associated with the first resource data structure a binary resource data structure that may be accessed by the first network element.

26. The method as set forth in claim 25, further comprising the step of storing data attribute values associated with the first resource data structure in a shared memory that may be accessed by the first network element.

27. The method as set forth in claim 24, wherein the network comprises a telecommunication network.

28. The method as set forth in claim 27, wherein the network comprises a wireless telecommunication network.

29. The method as set forth in claim 27, wherein the network comprises a wireline telecommunication network.

30. The method as set forth in claim 24, wherein the network comprises a data processing network.

31. The method as set forth in claim 30, wherein the network comprises a proprietary network.

32. The method as set forth in claim 31, wherein the network comprises one of: i) an enterprise network; ii) an industrial control system; and iii) a financial trading network.

33. The method as set forth in claim 31, wherein the network comprises a wide-area network.

34. The method as set forth in claim 31, wherein the network comprises a local-area network.

35. The method as set forth in claim 24, wherein the network comprises an Internet protocol network.
